(19) United States
(12) Patent Application Publication
(10) Pub. No.: US 2005/0205692 A1
(43) Pub. Date: Sep. 22, 2005

(54) Adjustable trigger spray gun

(76) Inventor: Brian Dean Edamura, Markham (CA)

Correspondence Address: RALPH A. DOWELL;DOWELL & DOWELL,P.C., 1215 JEFFERSON DAVIS HWY., SUITE309, ARLINGTON, VA, 22202, US

(21) Appl. No.: 10/802,035

(22) Filed: Mar. 17, 2004

(51) Int. Cl. B05B 9/04

(52) U.S. Cl. 239/526

(57) ABSTRACT

The present invention is directed to an adjustable spray gun attachment for use in association with a hose. The spray gun includes a body, a spray head and a trigger. The body has a conduit therethrough. The body is attachable to the hose whereby the hose is in flow communication with the conduit. The spray head is attached to the body in flow communication with the conduit. The trigger is attached to the body and is operably attached to the conduit whereby the conduit is opened responsive to movement of the trigger and the trigger has an adjustable at rest position.

### FIELD OF THE INVENTION

This invention relates to trigger spray gun attachments for garden hoses and in particular adjustable spray gun attachments for use with garden hoses.

### BACKGROUND OF THE INVENTION

Attachments for garden hoses are generally well known. There are a wide variety of different attachments for garden hoses. Some examples are sprinklers, nozzles, shut off valves and spray guns. Each attachment has a different purpose but each is designed to aid in the use of the garden hose.

Nozzles were an early improvement that allowed the user to adjust the spray from the hose. Thereafter, further improvements were suggested for example there are now a variety of different nozzles that allow the user to change the nozzle such that a spray, a mist, a gentle rain or a blast of spray are provided. A further improvement was an adjustable nozzle. The disadvantage of these earlier nozzles was that they were not easy to turn on or off. Typically the user had to rotate the nozzle a number of times to eventually turn it off. Alternatively the nozzle per se was not turned off rather the hose was turned off.

Accordingly, a spray gun was then suggested. The spray gun adapts a nozzle by adding a trigger which allows the user to easily turn on the hose. The hose is turned on by simply squeezing the trigger. The spray gun allows the user to control the spray from the hose close to the distal end of the hose. However, the spray guns that are generally available have a common flaw. These are generally, one size fits all. Therefore someone with a small hand often has difficulty using these spray gun type nozzles since it is difficult for their hand to span between the body of the spray gun and the trigger.

Accordingly, it would be advantageous to provide a spray gun that could be adjusted for different sized hands.

### SUMMARY OF THE INVENTION

The present invention is directed to an adjustable spray gun attachment for use in association with a hose. The spray gun includes a body, a spray head and a trigger. The body has a conduit therethrough. The body is attachable to the hose whereby the hose is in flow communication with the conduit. The spray head is attached to the body in flow communication with the conduit. The trigger is attached to the body and is operably attached to the conduit whereby the conduit is opened responsive to movement of the trigger and the trigger has an adjustable at rest position.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a perspective view of the adjustable trigger spray gun constructed in accordance with the present invention and showing a hose attached thereto;

FIG. 2 is a side view of the adjustable trigger spray gun of the present invention;

FIG. 3 is a front view of the adjustable trigger spray gun of the present invention;

FIG. 4 is a bottom view of the adjustable trigger spray gun of the present invention;

FIG. 5 is a partially broken away side view of the adjustable trigger spray gun shown in the large hand at rest position;

FIG. 6 is a partially broken away side view of the adjustable trigger spray gun shown in the large hand open position;

FIG. 7 is a partially broken away side view of the adjustable trigger spray gun shown in the small hand at rest position;

FIG. 8 is a partially broken away side view of the adjustable trigger spray gun shown in the small hand open position;

FIG. 9 is a blown apart perspective view of the adjustable trigger spray gun of the present invention; and

FIG. 10 is a perspective view of an alternate embodiment of the adjustable trigger spray gun of the present invention.

### DETAILED DESCRIPTION OF THE INVENTION

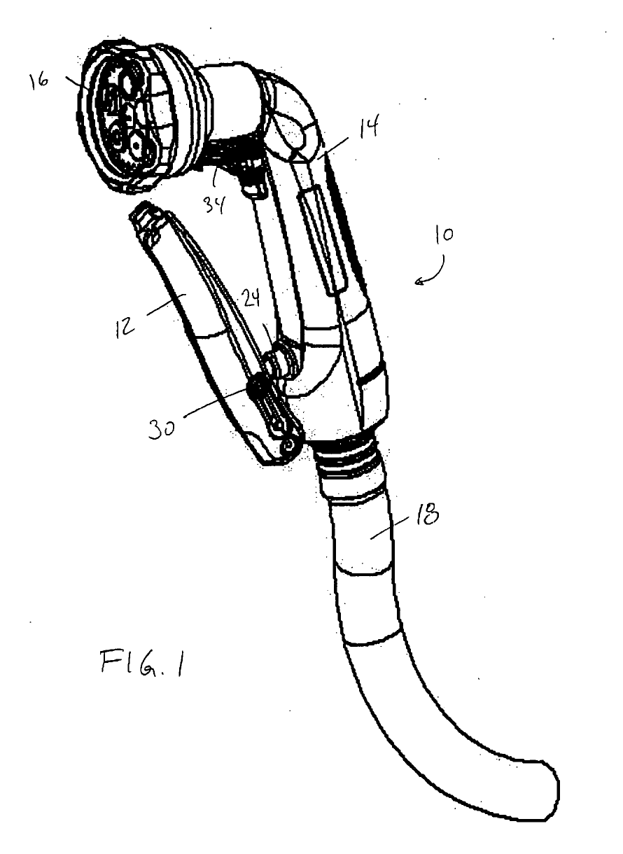

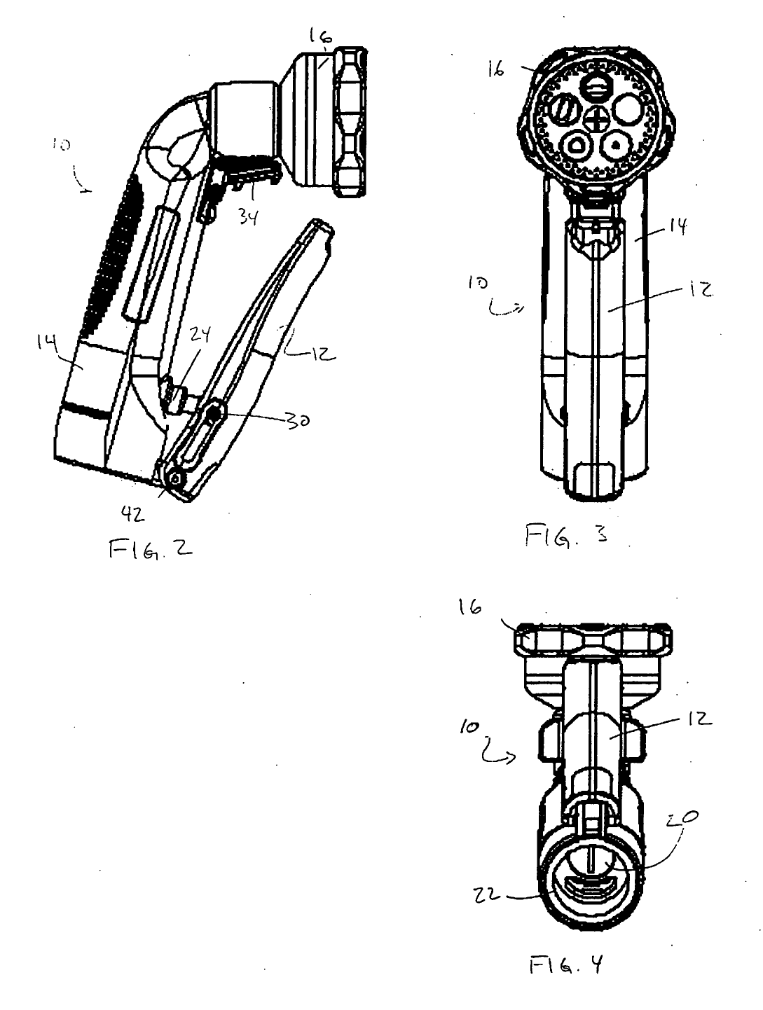

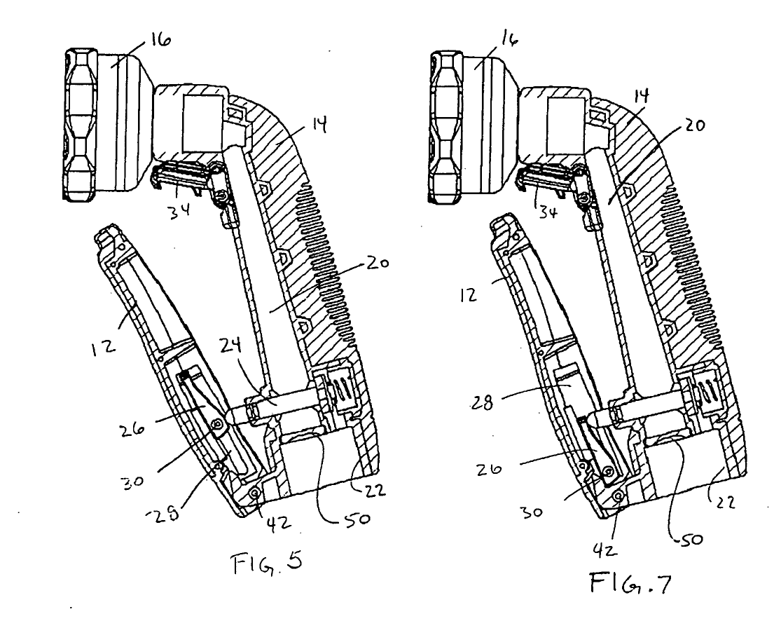

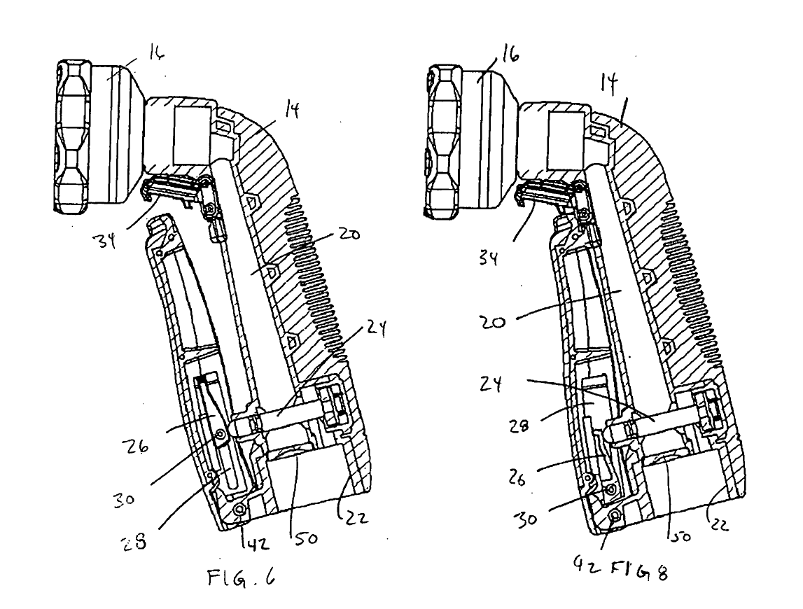

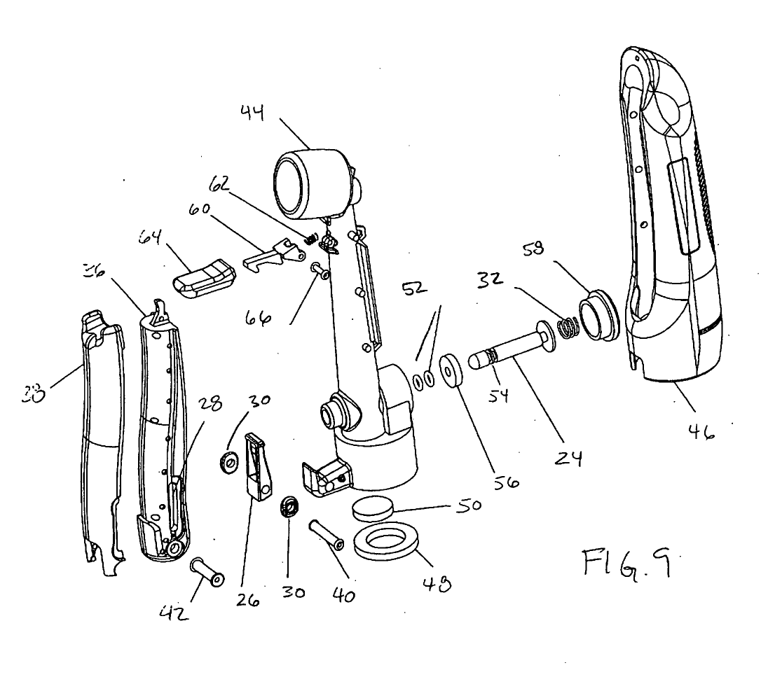

Referring to FIG. 1, the adjustable trigger spray gun attachment of the present invention is shown generally at 10. Adjustable trigger spray gun attachment 10 includes a trigger 12, a body 14 and a spray head 16. Adjustable spray gun attachment 10 is shown in FIG. 1 connected to a hose 18.

Adjustable spray gun attachment 10 has a trigger 12 that may be varied between the large hand position shown in FIGS. 5 and 6 and the small hand position shown in FIGS. 7 and 8. As can be seen in the figures in the at rest positions shown in FIGS. 5 and 7 the distance between the trigger 12 and the body 14 is greater in the large hand position than in the small hand position. Similarly in the open position shown in FIGS. 6 and 8 the distance between the trigger 12 and the body 14 is greater in the large hand position. This adjustability makes it easier for each hand size to grip the adjustable spray gun 10 of the present invention.

The body 14 is generally an elongate barrel shape. The spray head 16 is attached at one end thereof and the trigger 12 is pivotally attached at the other end thereof. Spray head 16 is a multi-spray head. The body has a conduit 20, shown in FIGS. 5 through 8, which is in flow communication with the head 16. One end of the conduit 20 is a connection 22 which is adapted to receive a hose 18 such that once attached the hose Is in flow communication with the conduit. A plunger 24 is used to open and close the conduit 20 responsive to movement of the trigger 12. A spring 32 biases the plunger 24 into the closed position. The plunger 24 is operably connected to the trigger 12 by the engaging a moveable cam 26 in the trigger 12. The cam 26 is shaped such that there is a narrow end which corresponds with the small hand setting and a wide end which corresponds with the large hand setting. The cam 26 is positioned in a cam channel 28. A pair of cam buttons 30 are attached to either side of the cam and are positioned on the outside of the trigger 12 such that a user moves the buttons to move the cam 26. The trigger 12 is provided with a trigger lock 34 so that the trigger 12 can be locked in the open position. By pivotally attaching the trigger to the bottom of the body 14 rather than the more conventional top pivot it is easier for the user to more leverage on the plunger 24.

Referring to FIG. 9 the spray gun 10 of the present invention is shown in a broken apart perspective view. The trigger 12 includes a trigger portion 36 and a trigger cover 38. Cam 26 is connected to the pair of cam buttons 30 with a cam rivet 40. Trigger 12 is pivotally attached to body 14 with pivot 42. The body 14 includes a body portion 44 which includes the conduit 20 (not visible) and a handle portion 46. A washer 48 is positioned in the connection 20 (not visible). A plug 50 is positioned in conduit 20 so that the flow of water is diverted to a side channel 51 portion where the plunger 24 is positioned, as best seen in FIGS. 5 through 8. The plunger 24 has a pair of O-rings 52 positioned in annular grooves 54. A plunger seal 56 is positioned around plunger 24 to further aid in sealing the plunger 24 in the conduit 20. A plunger cap 58 is positioned In conduit 20. The trigger lock 34 includes the lock portion 60, a spring 62 to keep the lock in position, a lock protective cover 64 and a rivet 66 to pivotally attach the lock to the body 14.

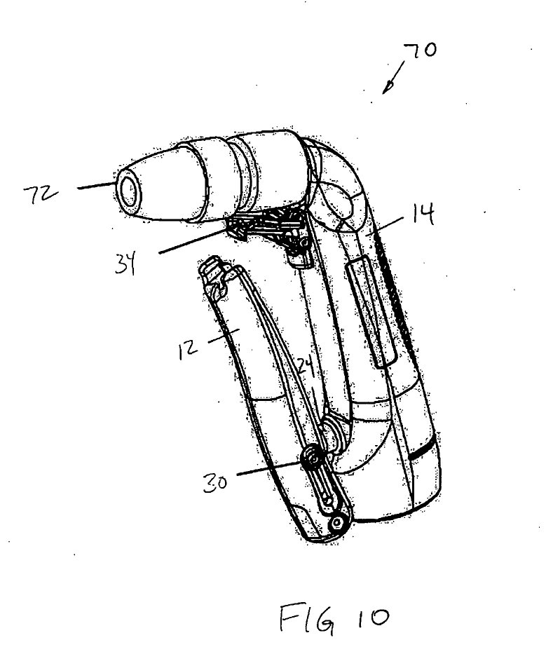

Referring to FIG. 10 an alternate embodiment of the adjustable trigger spray gun is shown generally at 70. This embodiment is the same as described above with the exception that in this embodiment the spray gun includes an infinite spray nozzle head 72. It will be appreciated by those skilled in the art that a wide variety of different heads could be used with the adjustable trigger spray gun of the present invention.

As used herein, the terms “comprises” and “comprising” are to be construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

It will be appreciated that the above description related to the invention by way of example only. Many variations on the invention will be obvious to those skilled in the art and such obvious variations are within the scope of the invention as described herein whether or not expressly described.

1. An adjustable spray gun attachment for use in association with a hose comprising:
a body having a conduit therethrough being attachable to the hose whereby the hose is in flow communication with the conduit;
a spray head attached to the body in flow communication with the body;
a trigger attached to the body and operably attached to the conduit whereby the conduit is opened responsive to movement of the trigger and the trigger has an adjustable at rest position.

2. An adjustable spray gun as claimed in claim 1 wherein the trigger is pivotally attached to the body.

3. An adjustable spray gun as claimed in claim 2 wherein the spray head is attached at one end of the body and the trigger is pivotally attached at the other end of the body.

4. An adjustable spray gun as claimed in claim 3 wherein the trigger is operably connected to a plunger whereby squeezing the trigger opens the plunger thereby opening the conduit.

5. An adjustable spray gun as claimed in claim 4 wherein the trigger includes an adjustable cam and the plunger engages the cam whereby when the plunger engages the cam at one end thereof the trigger is at a large hand position and when the plunger engages the cam at the other end thereof the trigger is at a small hand position and the large hand position is farther from the body than the small hand position.

6. An adjustable spray gun as claimed in claim 5 wherein the head is a multi-spray head.

7. An adjustable spray gun as claimed in claim 5 wherein the head is an infinite spray head.

8. An adjustable spray gun as claimed in claim 1 wherein the trigger includes an adjustable cam and the plunger engages the cam whereby when the plunger engages the cam at one end thereof the trigger is at a large hand position and when the plunger engages the cam at the other end thereof the trigger is at a small hand position and the large hand position is farther from the body than the small hand position.
